(19) United States
(12) Patent Application Publication
(10) Pub. No.: US 2014/0055263 A1
(43) Pub. Date: Feb. 27, 2014

(54) INFANT MONITOR

(71) Applicant: KONINKLIJKE PHILIPS N.V., EINDHOVEN (NL)

(72) Inventors: Erik Kurt Witt, Wyckoff, NJ (US); Mark Steven Aloia, Boulder, PA (US)

(73) Assignee: KONINKLIJKE PHILIPS N.V., EINDHOVEN (NL)

(21) Appl. No.: 14/008,106

(22) PCT Filed: Mar. 29, 2012
(86) PCT No.: PCT/IB2012/051510

§ 371 Date: Oct. 29, 2013

Related U.S. Application Data
(60) Provisional application No. 61/469,338, filed on Mar. 30, 2011.

(51) Int. Cl. G08B 21/02

(52) U.S. Cl. CPC G08B 21/0225
USPC 340/539.15

(57) ABSTRACT

Provided are systems and methods for infant monitoring. The systems and methods may include receiving sound produced by an infant, determining one or more characteristics of the sound, determining a recommendation relating to whether a caregiver should attend to the infant, based at least in part on the determined one or more characteristics, and outputting an indicator of the recommendation relating to whether a caregiver should attend to the infant.

The present disclosure pertains to systems and methods for infant monitoring, and, in particular, infant monitoring that incorporates at least one indicator to optimize caregiver response.

Typically, caregivers attend to an infant when the intensity and periodicity of crying or other demonstrative behavior by the infant is the highest or on the rise. However, this behavior reinforces the infant's incentive to cry and therefore may lead to greater instances of crying. Operant conditioning therapy may be utilized to reduce instances of crying by attending to infants only when crying or other demonstrative behavior is waning. However, it can often be difficult to determine when such activity is waning. Accordingly, systems and methods for providing an infant monitor that indicates when it is best to attend to an infant would be advantageous.

Accordingly, it is an object of one or more embodiments of the present invention to provide an infant monitor device comprising: at least a first a sound input device that receives sound produced by an infant; a controller configured to: determine one or more characteristics of the sound produced by the infant, and determine a recommendation relating to whether a caregiver should attend to the infant, based at least in part on the determined one or more characteristics; a first output device that outputs the received sound from the infant; and a second output device that outputs an indicator of the recommendation relating to whether a caregiver should attend to the infant.

It is yet another aspect of one or more embodiments of the present invention to provide a method for monitoring an infant using a monitor, the method comprising: receiving sound produced by an infant; a determining one or more characteristics of the sound produced by the infant; determining a recommendation relating to whether a caregiver should attend to the infant, based at least in part on the determined one or more characteristics; and providing an indicator of the recommendation relating to whether a caregiver should attend to the infant.

It is yet another aspect of one or more embodiments to provide an infant monitor device comprising: a sound input means for receiving sound produced by an infant; a controller means for: determining one or more characteristics of the sound produced by the infant, and determining a recommendation relating to whether a caregiver should attend to the infant, based at least in part on the determined one or more characteristics; a first output means for outputting the received sound from the infant; and a second output means for outputting an indicator of the recommendation relating to whether a caregiver should attend to the infant.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

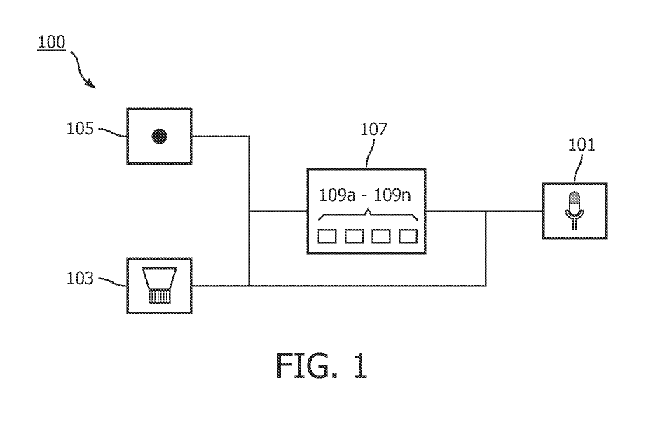

FIG. 1 illustrates an example of a system for infant monitoring, according to various embodiments of the invention;

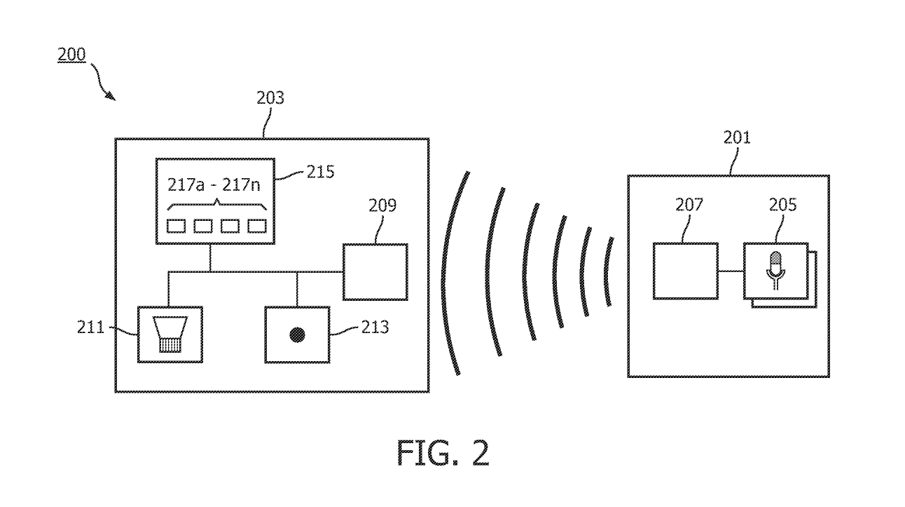

FIG. 2 illustrates an example of a system for infant monitoring, according to various embodiments of the invention; and

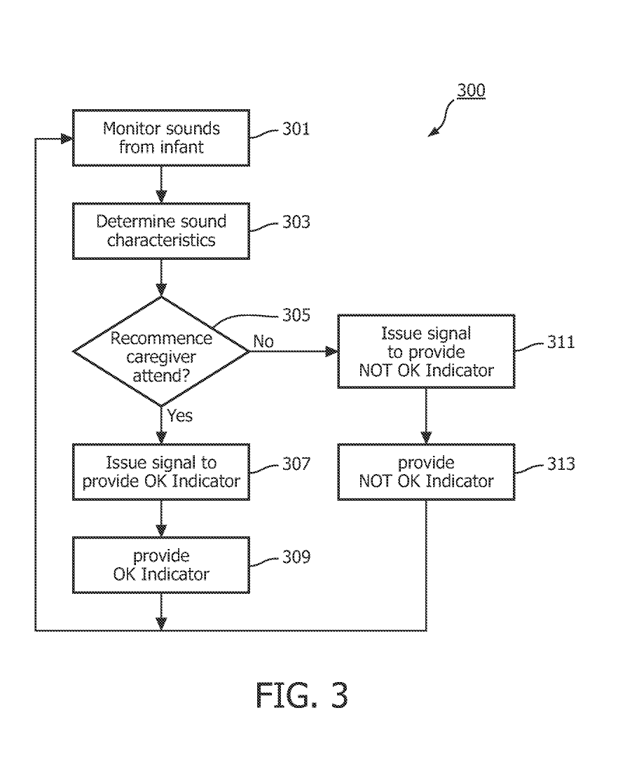

FIG. 3 illustrates an example of a process for infant monitoring, according to various embodiments of the invention.

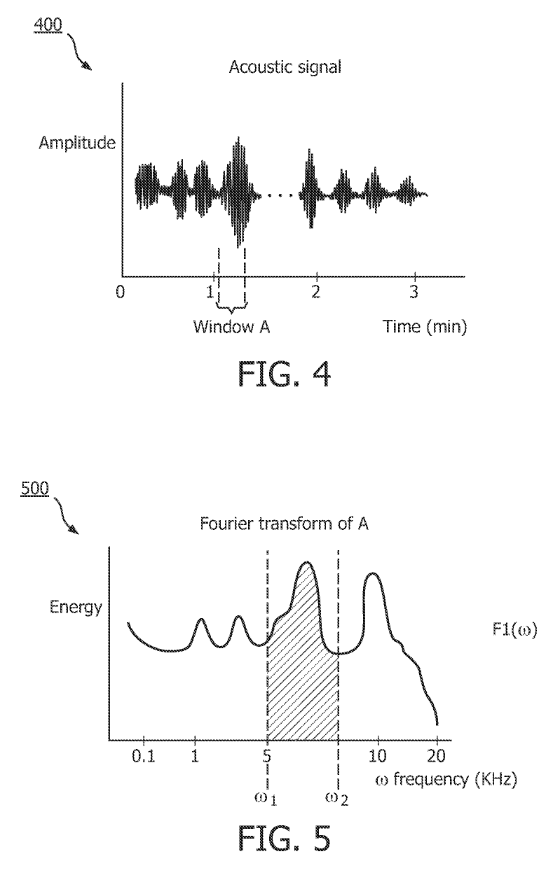

FIG. 4 illustrates an example of a plot sound amplitude from an infant over time, according to various embodiments of the invention.

FIG. 5 illustrates an example of a plot of a Fourier transform of a portion of sound from an infant, according to various embodiments of the invention.

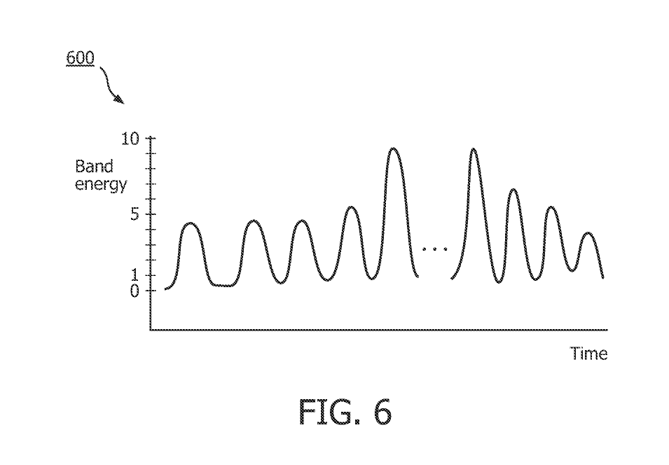

FIG. 6 illustrates an example of a plot of energy within a frequency band of sound over time, according to various embodiments of the invention.

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

In some embodiments, a system for infant monitoring is provided. FIG. 1 schematically illustrates a system 100, which is an example of a system for infant monitoring. System 100 may include at least one input device 101, a first output device 103, a second output device 105, a controller 107, and/or other elements. Connections between the various elements of system 100 may include one or more wired or wireless connections utilizing electrical, electromagnetic, or other signals for communication.

Input device 101 may include a microphone or other device that monitors sound (i.e., by converting sound waves into an electrical or electromagnetic signal). Accordingly, input device 101 monitors the sound in a given space such as, for example, a room where an infant (or other human or non-human animal of any age) is located. In some embodiments, the microphone is sensitive enough that most or all sounds made by the infant are detectable by system 100. Additional input devices may be used. For example, in some embodiments, additional microphones may be used to provide improved sound monitoring. In some embodiments, multiple microphones may be placed in different places in an area where an infant is located. In some embodiments, additional input devices may include still cameras, video cameras, or other input devices.

First output device 103 may include one or more speakers or other device that converts electrical/electromagnetic signals into sound and therefore outputs some or all of the sound monitored by input device 101. For example, in some embodiments, input device 101 converts sound in the area where an infant is located into electrical/electromagnetic signals. The signals are then transmitted to first output device 103, which converts them into sound to be heard by a listener (e.g., a parent or other caregiver). As such, system 100 enables a listener/caregiver in an area other than the area in which an infant is located to monitor the infant. In some embodiments, input device 101 may be wirelessly connected to first output device 103 so as to enable monitoring of an infant from greater distances.

Second output device 105 may include a display device such as, for example, one or more lights (of one or more colors), a display screen, or other display capable of providing one or more visual indicators. For example, second output device may include one or more light emitting diodes (LED) or other light emitting elements that provide a visual indicator. In some embodiments, a display screen (e.g., a liquid crystal display) may be used to provide one or more visual indicators such as, lights, shapes, alphanumeric text, pictures or other indicators.

Controller 107 may include one or more computer processing devices (e.g., microprocessors or other processing devices), associated memory, and/or other components. Controller 107 may include and/or access one or more modules 109a-109n which may include or comprise one or more software programs, computer-executable instructions, and/or data causing the one or more processing devices of controller 107 to perform one or more of the features or functions described herein. Modules 109a-109n may be stored on a hard disc, EPROM, EEPROM, other non-volatile memory, or other memory/storage device that is operatively connected to or in communication with the one or more processors of controller 107.

In some embodiments, modules 109a-109n may include one or more modules that receive signals from input device 101 or other input devices. These signals may include, for example, signals or data relating to sound in an area where an infant is located. In some instances, the sound in the area where an infant is located may include sounds generated by the infant such as, for example, voluntary vocal sounds (e.g., crying, talking, yelling, etc.), involuntary vocal sounds (e.g., coughing, sneezing, etc.), movement based sounds (e.g., kicking, etc., which may be voluntary or involuntary) or other sounds. As such, signals relating to the sounds generated by the infant may be received by controller 107.

In some embodiments, modules 109a-109n may include one or more modules that determine one or more characteristics of the received signals and/or information the received signals relate to. For example, as the received signals may relate to voluntary vocal sounds (e.g., crying/yelling) or other voluntary sounds (e.g., kicking), and as these types of sounds may be purposefully varied by the infant, the one or more determined characteristics may include an intensity of these sounds. This intensity may be measured using the loudness/amplitude/sound pressure of the voluntary sounds. In some embodiments, the intensity of the sounds may be measured in decibels, the amplitude of a waveform of the received sounds, or other intensity measurement. The one or more characteristics may also include the periodicity of the infant's voluntary sounds. The periodicity may include how often these voluntary sounds are made within any given period of time, the time interval between them, and/or other measurement. One or more of modules 109a-109n may include a pre-specified period of time within which these periodic frequency determinations are made. In some embodiments, intensity and periodicity may be used together. For example, in some embodiments, only sound within a given interval of a predetermined (or calculated) intensity may be considered for certain calculations/determinations used herein. Other characteristics or combinations thereof of infant sounds may also be determined/used.

In some embodiments one or more of modules 109a-109n may include one or more signal processing routines known in the art. These routines may include, for example, time-based, frequency based, or other transform methods. These routines may be tuned or trained to identify characteristics or properties of vocal sounds. These routines may be generalized (fixed), adaptive, or trained by users of system 100. In some embodiments, these or other routines may be used to determine whether sounds from an infant (e.g., crying or other voluntary sounds) are waxing, waning, or unchanging. FIG. 4 illustrates a graph 400, which is an example of a plot of the amplitude of received sound over a time period (3 min.) (the break in the plot represents a time during which, for example, the infant is crying consistently, and during which the sound bursts more or less repeat unchanged). Graph 400 includes an excerpted window indicated as “window A,” which stores a fixed number of samples from the sound level of a present time, back to a previous time (e.g., 0.5 second, 10,000 samples at 20 kJz sampling rate). It is continuously updated with time, at the sampling rate of the input sound signal. The contents of this window undergo a Fourier Transform. The Fourier transform is repeated every time the sound level window moves forward in time by one sample. FIG. 5 illustrates a graph 500, which is an example of a plot of a Fourier transformation of the excerpted window A of graph 400. The Fourier transformation of A is used to select/determine the frequency of sound that will be used to made recommendations regarding whether or not to attend to an infant. For example, the selected frequency may be the frequency of voluntary sounds (e.g., crying) produced by an infant relevant to such determinations/recommendations. In the example illustrated by graph 500, the selected frequency is within a range of about 5 KHz to about 8 KHz. Other frequencies or ranges may be used. The frequency band in the Fourier transform data can be adapted to individual babies and sound environment situations, so as to be optimally sensitive and specific, using known techniques.

The energy within a band (the integral of energy density from the Fourier transformation:

$${\int }_{ω 1}^{ω 2} ( ω ) = acoustic band energy )$$

is computed at the same sampling rate as the input sound signal. This signal is then plotted with respect to time. FIG. 6 illustrates a graph 600, which is an example such a plot. The plot of graph 600 enables tracking the band energy of sound at the selected frequency and thus a determination of its intensity and periodicity over a period of time. This tracking enables a determination of whether the voluntary sound (e.g., crying) or other sound produced by the infant is waxing, waning, or unchanging. The recommendation of whether to attend to the infant can then be based on this determination. In some embodiments, a peak sequence, p[n], from a plot such as that represented in graph 600 may be used to determine whether the crying from an infant is waxing or waning. For example, the peak sequence for graph 600 would be: 4, 4, 4, 5, 9, 9, 6, 5, 3. A peak difference, d[n]=p[n]−p[n−1], may then be calculated from the peak sequence. The peak difference for graph 600 would be: 4, 0, 0, 1,4, 0, −3, −1, −2. If d[n]>0, the crying (or other sound) is waxing. If d[n]=0, the crying (or other sound) remains unchanged. If d[n]<0, the crying (or other sound) is waning.

In some embodiments, only certain types of sounds may be considered when determining characteristics thereof. For example, in some embodiments, only voluntary vocal sounds may be used. In some embodiments, all voluntary sounds (where distinguishable) may used. In some embodiments, all sounds received by controller 107 may be used (as the vast majority of audible sounds in an area wherein an infant is located will be sounds usable for the purposes described herein).

In some embodiments, modules 109a-109n may make one or more additional determinations based on the determined characteristics of the received sounds. For example, one or more of modules 109a-109n may provide indicators that can be utilized by parents or caregivers of an infant to determine when to attend to the infant. As described herein, typically caregivers attend to an infant when the intensity and periodicity of crying or demonstrative behavior by the infant is the highest or on the rise. However, this behavior reinforces the infant's incentive to cry and therefore leads to greater instances of crying.

Operant conditioning therapy may be utilized to reduce instances of crying by attending to infants only when crying or other demonstrative behavior is waning. However, it can often be difficult to determine when such activity is waning. Accordingly, one or more of modules 109a-109n may determine a recommendation as to whether or not a caregiver should attend to an infant. The determined characteristics of voluntary sounds may be used to produce and indicator of this recommendation. For example, as described herein, the sound in the area where the infant is located may be continuously monitored by controller 107. Accordingly, as discussed above, the intensity and/or periodicity for the sound may be continuously determined or tracked by one or more of modules 109a-109n. One or more of modules 109a-109n may therefore also determine periods when crying (or other sound) is waxing (i.e., increasing in intensity), waning (i.e., decreasing in intensity), or unchanging. As discussed herein, in some embodiments, a recommendation of whether to attend to an infant may be based on whether the infant's crying is waxing (do not attend to infant) or waning (ok to attend to infant). Accordingly, one more of modules 109a-109n may include one or more thresholds for determining a period of time indicating that crying (or other sound) is waning before recommending that the infant be attended to. For example, referencing the peak detection sequences discussed herein, if 4 peaks in sequence indicate that crying is waning or 5 of 7 peaks indicate that crying is waning the recommendation may be provided. Other thresholds may be used. In some embodiments, the recommendation may be in real time based on each peak, such that each instance of d[n]<0 will produce a signal that it is recommended to attend to an infant and therefore the indicator of this recommendation will change in real time.

In some embodiments, as described herein, one or more routines (e.g., those determining sound intensity, periodicity, signal processing algorithms) may run in parallel generating characteristics that are used for pattern recognition. This pattern recognition may be used to determine one or more of several states of an infant such as, for example, quiet, crying, yelling, babbling, happy, stressed, indeterminate, or other state. These determined states may be used to provide indicators identifying a current state to a caregiver or other user.

Accordingly, one or more of modules 109a-109n may include one or more algorithms and/or thresholds used to determine the recommendation as to whether it is a good time to attend to the infant without reinforcing crying or other demonstrative behavior. When controller 107 determines the recommendation, an indicator relating to this recommendation may be produced. To provide this indicator, one or more of modules 109a-109n may generate a signal to second output device 105, instructing second output device 105 to generate the indicator.

In some embodiments, the indicators are binary (i.e., yes/no) indicators. For example, in some embodiments, the indicator may include “turning on” a light (e.g., the light being on may indicate that the recommendation so that it is ok to attend to the infant, while the light being off may indicate that it is not recommended to attend to the infant; however, the opposite arrangement may also be used.). As another example, in some embodiments, a light of one color (e.g., red, indicating that it is not recommended to attend to the infant) may be changed to a different color (e.g., green, indicating that it is ok to attend to the infant). Other colors may be used, as well as shapes, alphanumeric text, or other visual indicators may also be used in binary indicating schemes.

In some embodiments, the indicators may include three or more “levels” providing an indication of degree. For example, a red light may indicate a strong discouragement of attending to the infant, a yellow light may indicate a mild discouragement of attending to the infant, and a green light indicating no discouragement of attending to the infant. Other lighting/color schemes may be used, as well as shapes or alphanumeric text (provided via a display screen), or other visual indicators providing non-binary schemes.

In some embodiments, one or more of modules 109a-109n may transmit signals relating to sounds received by input device 101 to first output device 103 so that these sounds may be heard by a caregiver. This enables the caregiver to utilize the infant monitor as a traditional infant monitor and therefore utilize judgment as to whether to attend to the infant. As some embodiments, system 100 may include input devices and output devices relating to still pictures or video. As such, signals relating to such data may also be transmitted by one or more of modules 109a-109n. In some embodiments, transmission of audio, picture, and/or video signals from an input device (e.g., input device 101) to an output device (e.g., first output device 103) may be direct or otherwise may not involve controller 107 (while controller 107 may still separately and contemporaneously receive such signals for the purpose of determining whether to produce an indicator recommending whether or not to attend to the infant).

Other configurations for systems for an improved infant monitor may be provided. FIG. 2 is illustrates a system 200, which is an example of a system for infant monitoring. System 200 may include a transmitter unit 201 and a receiver unit 203. Transmitter unit 201 may include at least one input device 205 and a transmitter 207. Input device 205 may be similar to input device 101 as described in system 100. For example, input device 205 may include a microphone or other device that monitors sound. Other input devices may be used (e.g., additional microphones and/or still picture/video input devices). Transmitter 207 may include a device that receives signals (e.g., relating to sound or other signals) from input device 205 and wirelessly transmits the signals as electromagnetic waves (e.g., radio waves). In some embodiments, input device 205 and transmitter 207 may be encased in a single housing.

Receiver unit 203 may include a receiver 209, a first output device 211, a second output device and a controller 215. Receiver 209 receives the electromagnetic signals from transmitter 207. First output device 211 may receive signals from receiver 209 and may use such signals to reproduce sound monitored by input device 205. For example, first output device may be similar to first input device 103 of system 100 in that is may include one or more speakers or other devices that convert electrical signals into sound. In some embodiments, first output device 211 may receive signals for reproducing sounds monitored by input device 205 from controller 215 or from elsewhere.

Second output device 213 may include may include a display device such as, for example, one or more lights, a display screen, or other display capable of providing one or more visual indicators similar to second output device 105 of system 100.

Controller 215 may be similar to controller 107 of system 100 in that it may include one or more computer processing devices (e.g., microprocessors or other processing devices), associated memory, and/or other components. Controller 215 may likewise include and/or access one or more modules 217a-217n (providing the features and functions described herein with respect to one or more modules 109a-109n) which may include or comprise one or more software programs, computer-executable instructions, and/or data causing the one or more processing devices of controller 215 to perform one or more of the features or functions described herein, including: receiving signals relating to sounds in an area where an infant is located, determining characteristics of these sounds and signal processing, determining recommendations relating to whether a caregiver should attend to an infant, initiating an indicator relating to this recommendation, and/or other features or functions.

In some embodiments, receiver 209, first output device 211, second output device 213, and controller 215 may be encased in a single housing. In some embodiments, one or more components of receiver unit 203 may be located elsewhere. For example, in some embodiments, controller 215 may be located in a housing of transmitter unit 201. Other configurations may also be used as would be appreciated by those having skill in the art.

In some embodiments, a method for infant monitoring may be provided. FIG. 3. illustrates a process 300, which is an example of a process for providing infant monitoring. Process 300 may include an operation 301, wherein information regarding sounds in an area where an infant is located are monitored. In some embodiments, these sounds may include voluntary vocal sounds (e.g., crying, talking, yelling, etc.), involuntary vocal sounds (e.g., coughing, sneezing, etc.), movement based sounds (e.g., kicking, etc., which may be voluntary or involuntary), or other sounds. In some embodiments, an input device (e.g., input device 101 of system 100 or input device 205 of system 200) may convert the sounds in an area where the infant is located into signals, which are then sent to and received by a controller (e.g., controller 107 of system 100 or controller 215 of system 200).

In an operation 303, one or more characteristics of the sounds in the area where the infant is located are determined. The one or more characteristics may include an intensity of the sounds, a periodicity of the sounds, and/or other characteristics. In some embodiments, determining the one or more characteristics may include determining whether the intensity and or periodicity of sounds in the area where the infant is located are waxing, waning, or unchanging (e.g., using the peak detection methods discussed herein). In some embodiments, these determinations may be made at, for example, one or more of modules 109a-109n of controller 107 or modules 217a-217n of controller 215.

In an operation 305, a determination may be made, based at least in part on the determined characteristics, whether it is recommended for a caregiver to attend to the infant. In some embodiments, these determinations may be made at, for example, one or more of modules 109a-109n of controller 107 or modules 217a-217n of controller 215.

As will be appreciated by those skilled in the art, a recommendation to attend to the infant is not based on a determination that the infant is in distress or otherwise in need of assistance, but rather is based on a determination that attending to the infant will not reinforce negative behavior. Accordingly, a recommendation to attend to the infant may also be interpreted as a determination that it is “ok” to attend to the infant. As discussed herein, in some embodiments, when it is determined that the intensity and/or periodicity of cries (or other voluntary sounds produced by the infant) are waning (e.g., decreasing) a recommendation that it is ok to attend to the infant may be made. Conversely, when it is determined that the intensity and/or periodic frequency of cries (or other voluntary sounds produced by the infant) are waxing (e.g., decreasing) or peaking, the recommendation may be to not attend to the infant.

If, in operation 305, it is determined that it is recommended for a caregiver to attend to the infant (e.g., that it is ok to do so), a signal to provide an indicator to this effect (also referred to herein as an “OK indicator”) may be issued to an output device in an operation 307. For example, one or more of modules 109a-109n of controller 107 or modules 217a-217n of controller 215 may issue this signal to second output device 105 of system 100 or second output device 213 of system 200.

In an operation 309, as a result the signal to provide the OK indictor being sent to an output device, the output device provides the OK indicator. In some embodiments, providing the OK indictor may include switching on a light (or switching off a light), changing an emitted light from a first color (e.g., red, recommending that the caregiver not attend to the infant) to a second color (e.g., green, indicating that it is ok to attend to the infant). In some embodiments, the OK indicator may include providing one or more shapes, pictures, alphanumeric text, or other indicator that it is recommended to attend to the infant. Other types of indicators may be used. As described herein, in some embodiments, second output device 105 of system 100 or second output device 213 of system 200, may provide the OK indicator to the a caregiver as described herein.

After operation 309, process 300 may return to operation 301, wherein monitoring of the sound in the area where the infant is located is continued.

If, in operation 305, it is determined that it is not recommended for a caregiver to attend to the infant, a signal to provide an indicator to this effect (also referred to herein as an “NOT OK indicator”) may be issued to an output device in an operation 311. For example, one or more of modules 109a-109n of controller 107 or modules 217a-217n of controller 215 may issue this signal to second output device 105 of system 100 or second output device 213 of system 200.

In an operation 313, as a result the signal to provide the NOT OK indictor being sent to an output device, the output device provides the NOT OK indicator. In some embodiments, providing the NOT OK indictor may include switching off a light (or switching on a light), changing an emitted light from a second color (e.g., green, indicating that it is ok to attend to the infant) to a first color (e.g., red, recommending that the caregiver not attend to the infant). In some embodiments, the NOT OK indicator may include providing shapes, pictures, alphanumeric text or other indicators that it is not recommended to attend to the infant. As described herein, in some embodiments, second output device 105 of system 100 or second output device 213 of system 200, may provide the NOT OK indicator to the a caregiver as described herein.

After operation 313, process 300 may return to operation 301, wherein monitoring of the sound in the area where the infant is located is continued.

As described herein, in some embodiments, the recommendation of whether or not to attend to the infant may be binary (e.g., OK vs NOT OK). However, in some embodiments, the recommendation (and therefore the indicators thereof) may include a number of levels, each of which provides an indication of the degree of recommendation (e.g., strongly not recommended, mildly not recommended, mildly recommended, strongly recommended, etc.). In such embodiments, the determination of whether to recommend that a caregiver attend to the infant (e.g., the determination of operation 305 of process 300) may be a determination of what level of recommendation to make. This determination may be based on one or more thresholds for the one or more determined characteristics for each level. Signals causing indicators of such may then be sent to an out put device (e.g., second output devices 105 or 213) causing the indicators to be provided. In some embodiments, pattern recognition may be utilized to determine one or more of several states of an infant such as, for example, quiet, crying, yelling, babbling, happy, stressed, indeterminate, or other state. These determined states may be used to provide indicators identifying a current state to a caregiver or other user via, e.g., a display screen or other output device.

In some embodiments, tangible computer-readable media comprising computer-executable instructions for causing one or more computer processors to perform one or more of the features and functions set forth herein, including the operations of the methods described herein, may be provided.

The systems described herein are exemplary system configurations. Other configurations may exist. Those having skill in the art will appreciate that the invention described herein may work with various configurations. Accordingly, more or less of the aforementioned system components may be used and/or combined in various embodiments. It should also be understood that various software modules 109a-109, and 217a-217n that are utilized to accomplish the functionalities described herein may be maintained on different components than controllers 107 or 215, as desired or necessary. In other embodiments, as would be appreciated, the functionalities described herein may be implemented in various combinations of hardware and/or firmware, in addition to, or instead of, software. Furthermore, various operations of the methods described herein, while described in a particular order, may be performed in different orders as would be appreciated by those having skill in the art. In some embodiments, more of less of the described operations may be used.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. An infant monitor device comprising:
a first sound input device that receives sound produced by an infant;
a controller configured to:
determine one or more characteristics of the sound produced by the infant, wherein the one or more characteristics include an intensity of sound produced by the infant in a frequency range characteristic for audible crying of infants, and
determine a recommendation relating to whether a caregiver should attend to the infant, based on a decrease in the determined intensity of the sound produced by the infant;
a first output device that outputs the received sound from the infant; and
a second output device that outputs an indicator indicating the recommendation relating to whether a caregiver should attend to the infant.

2. The infant monitor device of claim 1, wherein the controller is configured to detect peaks in the intensity of the sound produced by the infant, and wherein the decrease in the determined intensity includes a decrease in multiple subsequent detected in intensity of the sound provided by the infant.

3. The infant monitor device of claim 1, wherein the recommendation includes three or more levels, and Wherein the second output device outputs an indicator that corresponds to the three or more levels of the recommendation.

4. The infant monitor device of claim 1, wherein the second output device includes one or more light emitting devices.

5. The infant monitor device of claim 1, wherein the second output device includes a display capable of providing alphanumeric text.

6. A method for monitoring an infant using a monitor, the method comprising:
receiving sound produced by an infant;
determining one or more characteristics of the sound produced by the infant, wherein the one or more characteristics include an intensity of sound produced by the infant in a frequency range characteristic for audible crying of infants;
determining a recommendation relating to whether a caregiver should attend to the infant, based on a decrease in the determined intensity of the sound Produced by the infant; and
providing an indicator indicating the recommendation relating to whether a caregiver should attend to the infant.

7. The method of claim 6, further comprising:
Detecting peaks in the intensity of the sound produced by the infant,
wherein the determination of the recommendation is based on a decrease in multiple subsequent detected peaks in intensity of the sound produced by the infant.

8. The method of claim 6, wherein the recommendation includes three or more levels and wherein the provided indicator corresponds to the three or more levels of the recommendation.

9. The method of claim 6, wherein providing the indicator of the recommendation includes emitting a specified color of light.

10. The method of claim 6, wherein providing the indicator of the recommendation includes providing alphanumeric text.

11. An infant monitor device comprising:
a sound input means for receiving sound produced by an infant;
a controller means for:
determining one or more characteristics of the sound produced by the infant, wherein the one or more characteristics include an intensity of sound produced by the infant in a frequency rage characteristic for audible crying of infants, and
determining a recommendation relating to whether a caregiver should attend to the infant, based on a decrease in the determined intensity of the sound produced by the infant;
a first output means for outputting the received sound from the infant; and
a second output means for outputting an indicator indicating the recommendation relating to whether a caregiver should attend to the infant.

12. The infant monitor device of claim 11, wherein the one or more characteristics include one or more of the intensity of the sound produced by the infant or the periodicity of the sound provided by the infant.

13. The infant monitor device of claim 12, wherein the controller means is further configured to detect peaks in the intensity of the sound produced by the infant, and wherein the determination of the recommendation is based on a decrease in multiple subsequent detected peaks in intensity of the sound produced by the infant.

14. The infant monitor device of claim 11, wherein the second output means includes one or more light emitting means.

15. The infant monitor device of claim 11, wherein the second output means includes means for providing alphanumeric text.
